(19) United States
(12) Patent Application Publication
(10) Pub. No.: US 2010/0295547 A1
(43) Pub. Date: Nov. 25, 2010

(54) Downhole Resistivity Receiver with Canceling Element

(76) Inventors: David R. Hall, Provo, UT (US); Harold Snyder, Rockwall, TX (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/846,348

(22) Filed: Jul. 29, 2010

Related U.S. Application Data
(63) Continuation-in-part of application No. 12/341,771, filed on Dec. 22, 2008.
Application No. 12/341,771 is a continuation-in-part of application No. 11/776,447, filed on Jul. 11, 2007, now Pat. No. 7,598,742.
Application No. 11/776,447 is a continuation-in-part of application No. 11/676,494, filed on Feb. 19, 2007, now Pat. No. 7,265,649.
Application No. 11/676,494 is a continuation-in-part of application No. 11/687,891, filed on Mar. 19, 2007, now Pat. No. 7,301,429.
(60) Provisional application No. 60/914,619, filed on Apr. 27, 2007.

(51) Int. Cl. G01V 3/18

(52) U.S. Cl. 324/339

(57) ABSTRACT

A downhole tool assembly comprising at least one downhole tool string component. The downhole tool string component comprises at least one transmitter. The transmitter is attached to a primary signal generator and transmits a primary signal into the surrounding earth formation. The primary signal creates an induced or reflected signal within the formation which may reveal information regarding the formation. The downhole tool string component also comprises at least one receiver. The receiver is adapted to measure the signal induced or reflected in the formation. The downhole tool sting component also comprises at least one active coil or piezoelectric transducer proximate the receiver. The active coil or piezoelectric transducer is adapted to substantially cancel the primary signal generated by the transmitter and allow the receiver to focus on the induced or reflected signal.

### CROSS REFERENCE TO RELATED APPLICATIONS

This application is a continuation-in-part of U.S. patent application Ser. No. 12/341,771 filed on Dec. 22, 2008, which is a continuation-in-part of U.S. patent application Ser. No. 11/776,447 filed on Jul. 11, 2007 which claims priority to Provisional U.S. Patent Application No. 60/914,619 filed on Apr. 27, 2007 and entitled “Resistivity Tool.” This application is also a continuation-in-part of U.S. patent application Ser. Nos. 11/676,494; 11/687,891; 61/073,190. All of the above mentioned references are herein incorporated by reference for all that they contain.

### BACKGROUND OF THE INVENTION

The present invention relates to the field of downhole oil, gas and/or geothermal exploration and more particularly to the fields of resistivity tools tools for tool strings employed in such exploration.

Engineers in the oil, gas, and geothermal fields have worked to develop machinery and methods to effectively obtain information about downhole formations, especially during the process of drilling. Logging-while-drilling (LWD) refers to a set of processes commonly used in the art to obtain information about a formation during the drilling process. Such information may be used by downhole tool string components or be transmitted to the earth's surface.

Information regarding the electric resistivity of a downhole formation is one parameter that may be valuable to a drilling operation. There are two common types of resistivity measuring systems. Laterolog resistivity systems pass an electrical current through the formation while induction resistivity systems induce a magnetic field in the formation.

In induction resistivity systems, a magnetic field is typically generated by a transmitter. This transmitter is generally formed by wrapping a wire into a coil and then passing an electrical signal through the coil. This coil may be wrapped around a magnetic core. The electrical current passed through the coil causes an electromagnetic field to emanate into the surrounding formation. The generated field will cause currents to run through the formation and an induced electromagnetic field will be generated.

A receiver is then used to measure the induced field and assumptions may be made regarding the contents of the formation based on those measurements with reference to the original transmitted signal. A receiver is generally formed similarly to the transmitter in that a wire is typically wrapped into a coil. The coil may be wrapped around a magnetic core. In a receiver, the coil is typically passive and connected to a measuring instrument. When the receiver comes into contact with an electromagnetic field a current is created in the wire which can be measured.

One of the issues that negatively affects this method of measurement is that the passive receiver coils may pick up both the induced electromagnetic field in the formation as well as the generated field produced by the transmitter. These fields are typically at different magnitudes and phases, thus requiring the receiver to sense a wide range of signals at the expense of dynamic range. This results in a lower resolution of the field of interest, i.e. the induced field from the formation.

In an attempt to reduce this problem some have added reverse winding to the passive receiver coil creating a nulling coil. The number of reverse turns the passive coil is wound depends on the distance from the transmitter. However, this method has some limitations in that (a) the distance of the receiver to the transmitter varies, (b) the number of reverse windings generally cannot be changed once the tool is beneath the surface, and (c) the affect of the reverse windings vary with temperature and pressure.

The prior art contains references to drill bits with sensors or other apparatuses for data retrieval.

U.S. Pat. No. 6,677,756 to Fanini, et al, which is herein incorporated by reference for all that it contains, discloses an induction tool for formation resistivity evaluations. The tool provides electromagnetic transmitters and sensors suitable for transmitting and receiving magnetic fields in radial directions.

U.S. Pat. No. 7,141,981 to Folbert, et al, which is herein incorporated by reference for all that it contains, discloses a resistivity logging tool suitable for downhole use that includes a transmitter, and two spaced apart receivers. The measured resistivities at the two receivers are corrected based on measuring the responses of the receivers to a calibration signal.

U.S. Pat. No. 5,606,260 to Giordano, et al, which is herein incorporated by reference for all that it contains, discloses a microdevice provided for measuring the electromagnetic characteristics of a medium in a borehole. The microdevice includes at least one emitting or transmitting coil, and at least one receiving coil. The microdevice generates an A.C. voltage at the terminals of the transmitting coil and measures a signal at the terminals of the receiving coil. The microdevice also includes an E-shaped electrically insulating, soft magnetic material circuit serving as a support for each of the coils and which is positioned adjacent to the medium in the borehole.

Not withstanding the preceding patents regarding LWD measurement tools, there remains a need in the art for an enhanced method of reducing the affect of the primary generated electromagnetic field at the receiver. This enhanced method should allow for receivers being placed at varying distances from the transmitter without the need to retune the reverse windings. Thus, further advancements in the art are needed.

### BRIEF SUMMARY OF THE INVENTION

A downhole tool assembly comprises a transmitter. In various embodiments the transmitter may comprise an electromagnetic transmitter. In one embodiment the transmitter may comprise an electromagnetic transmitter, adapted to generate an electromagnetic field. The electromagnetic field generated by the transmitter is capable of inducing an induced field in the earthen formation generally surrounding the downhole tool assembly.

At least one receiver is spaced apart from the transmitter. In various embodiments the receiver could comprise an electromagnetic receiver. In one embodiment, the receiver is adapted to measure an induced field created within the formation.

A canceling element is located proximate the receiver. In various embodiments the canceling element may comprise an active coil or a piezoelectric transducer. In one embodiment the canceling element comprises an active coil that is adapted to generate a canceling field capable of canceling the electromagnetic field generated by the transmitter. This canceling field generated by the active coil may allow the receiver to measure less of the electromagnetic field generated by the transmitter and more of the induced field in the formation.

The transmitter and/or at least one of the receivers may comprise a magnetic core disposed substantially parallel with an axis of the tool assembly and wrapped with wire. The transmitter and/or at least one of the receivers may also comprise a plurality of circumferentially spaced units that are independently excitable. The units may also be tilted with respect to the central axis or substantially perpendicular to one another.

The canceling element may comprise an active coil. The active coil may comprise a magnetic core wrapped with wire or may comprise wire wrapped around the same magnetic core as the receiver. The active coil may comprise a magnetic core disposed substantially parallel with an axis of the tool assembly and wrapped with wire. The active coil may also comprise a plurality of circumferentially spaced units that are independently excitable. The active coil may also be tilted with respect to the central axis or substantially perpendicular to other units or transmitters.

The downhole assembly may be a bottom hole assembly, a downhole string component, a wire-line tool, or other downhole tool.

### BRIEF DESCRIPTION OF THE DRAWINGS

FIG. 1 is a side-view diagram of an embodiment of a downhole tool string assembly.

FIG. 2 is a side-view diagram of an embodiment of tool string component.

FIG. 3a is a side-view diagram of an embodiment of a transmitter as part of a tool string component.

FIG. 3b is a side-view diagram of an embodiment of a receiver and active coil as part of a tool string component.

FIG. 4a is a perspective diagram of an embodiment of a receiver unit and active coil.

FIG. 4b is a perspective diagram of another embodiment of a receiver unit and active coil.

FIG. 4c is a cutaway perspective diagram of the embodiment of the receiver unit and active coil of FIG. 4b.

FIG. 4d is a top-view diagram of an embodiment of a receiver unit and active coil.

FIG. 4e is a top-view diagram of another embodiment of a receiver unit and active coil.

FIG. 4f is a top-view diagram of another embodiment of a receiver unit and active coil.

FIG. 5a is a perspective diagram of an embodiment of a spool receiver and active coil.

FIG. 5b is a perspective diagram of another embodiment of a spool receiver and active coil.

FIG. 5c is a cutaway perspective diagram of the embodiment of the spool receiver and active coil of FIG. 5b.

FIG. 6a is a side view of an embodiment of a transmitter as part of a tool string component.

FIG. 6b is a side view of an embodiment of a receiver and active coil as part of a tool string component.

FIG. 7a is a side-view diagram of an embodiment of a transmitter as part of a tool string component.

FIG. 7b is a side-view diagram of an embodiment of a receiver and active coil as part of a tool string component.

FIG. 8a is a side-view diagram of an embodiment of an irradiated plastic cover as part of a tool string component.

FIG. 8b is a side-view diagram of an embodiment of a cover comprising irradiated plastic windows as part of a tool string component.

FIG. 9 is a cross-sectional diagram of an embodiment of a tool string component within a formation.

FIG. 10a is a side-view diagram of an embodiment of a transmitter as part of a tool string component with electronic assemblies exposed.

FIG. 10b is a side-view diagram of an embodiment of a receiver and active coil as part of a tool string component with electronic assemblies exposed.

FIGS. 11a, 11b, and 11c are graphs of representative electromagnetic fields.

FIG. 12 is a block diagram of an embodiment of a resistivity receiver with cancelling element.

### DETAILED DESCRIPTION OF THE INVENTION AND THE PREFERRED EMBODIMENT

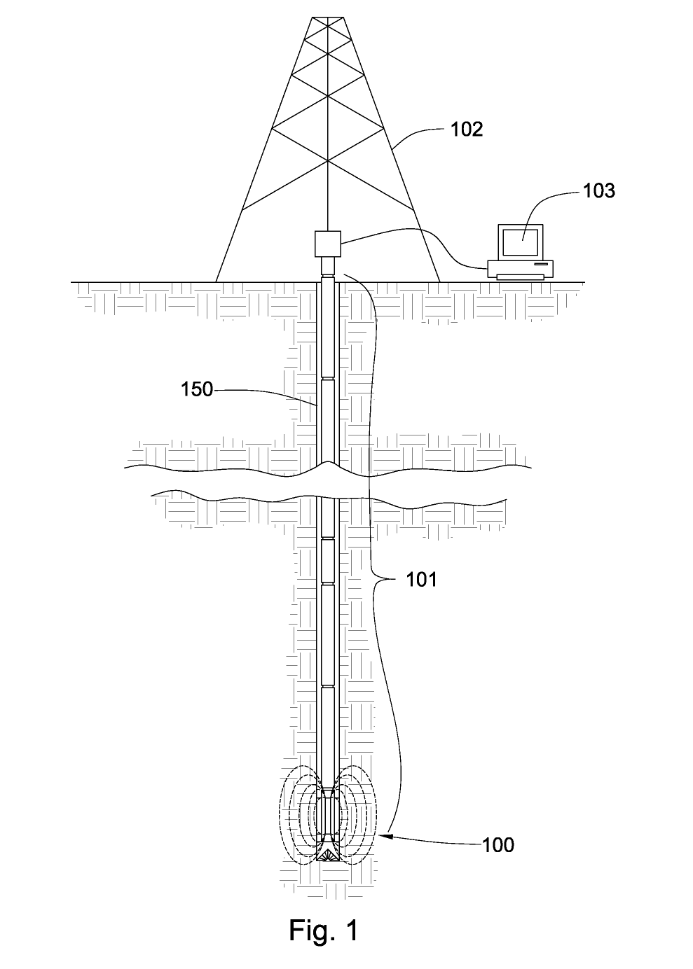

Referring now to FIG. 1, a downhole tool string 101 may be suspended by a derrick 102 in a borehole 150. The tool string 101 may comprise one or more tool string components 100, linked together in a tool string 101 and in communication with surface equipment 103 through a downhole network. Networks in the tool string 101 may enable high-speed communication between devices connected to the tool string, and the networks may facilitate the transmission of data between sensors and sources. The data gathered by the tool string components 100 may be processed downhole, may be transmitted to the surface for processing, may be filtered downhole and then transmitted to the surface for processing or may be compressed downhole and then transmitted to the surface for processing.

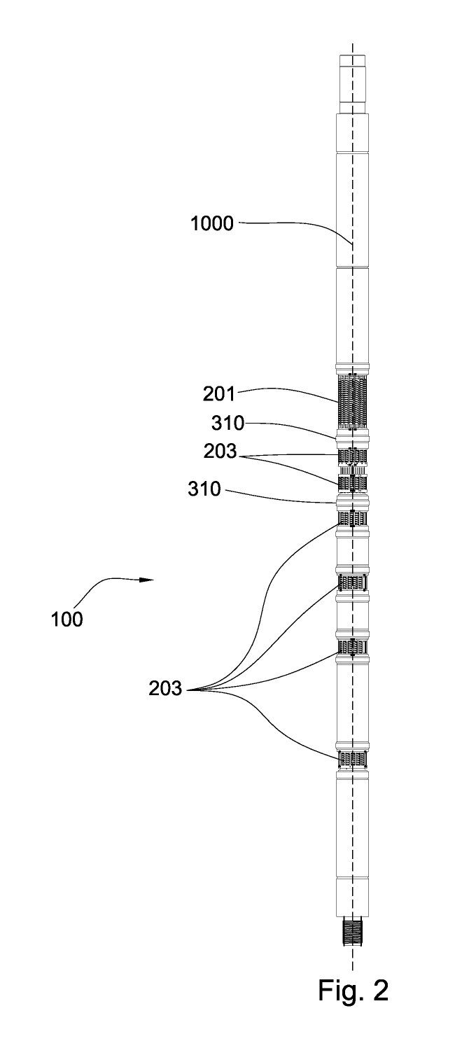

FIG. 2 is an embodiment of a tool string component 100. The tool string component may comprise a transmitter 201 and a plurality of receivers 203. The receivers 203 may be placed in a variety of orientations with respect to each other and to the transmitter 201. The transmitter 201 is adapted to send an induction signal into the formation, which generates an induced field in the formation surrounding the borehole 150. The receivers 203 may be adapted to sense various attributes of the induction field in the formation. These attributes may include among others, some or all of the following: frequency, amplitude, or phase. The receivers 203 may also be adapted to sense the earth's magnetic field in the formation. The transmitter and the receivers may be powered by batteries, a turbine generator or from the downhole network. The receivers may also be passive. In some embodiments, there may be several transmitters located along the length of the tool string component. In some embodiments, the additional transmitters may be used to calibrate measurements, such as is common in borehole compensation techniques.

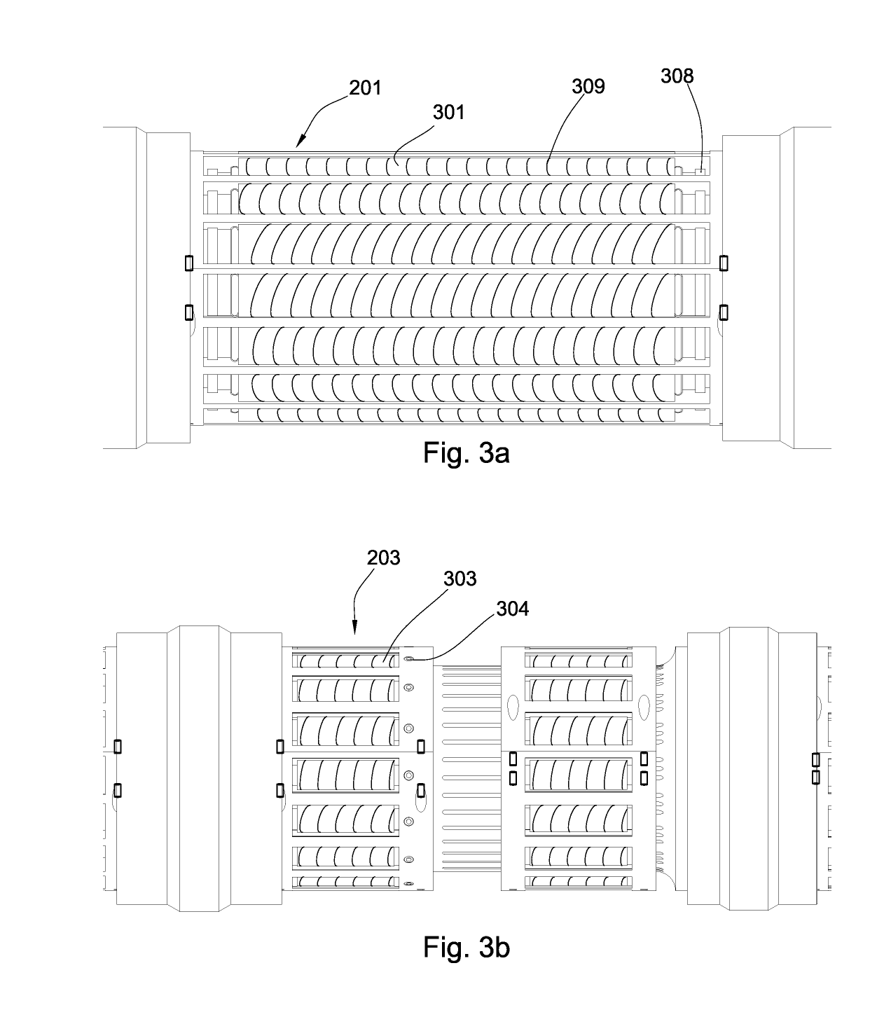

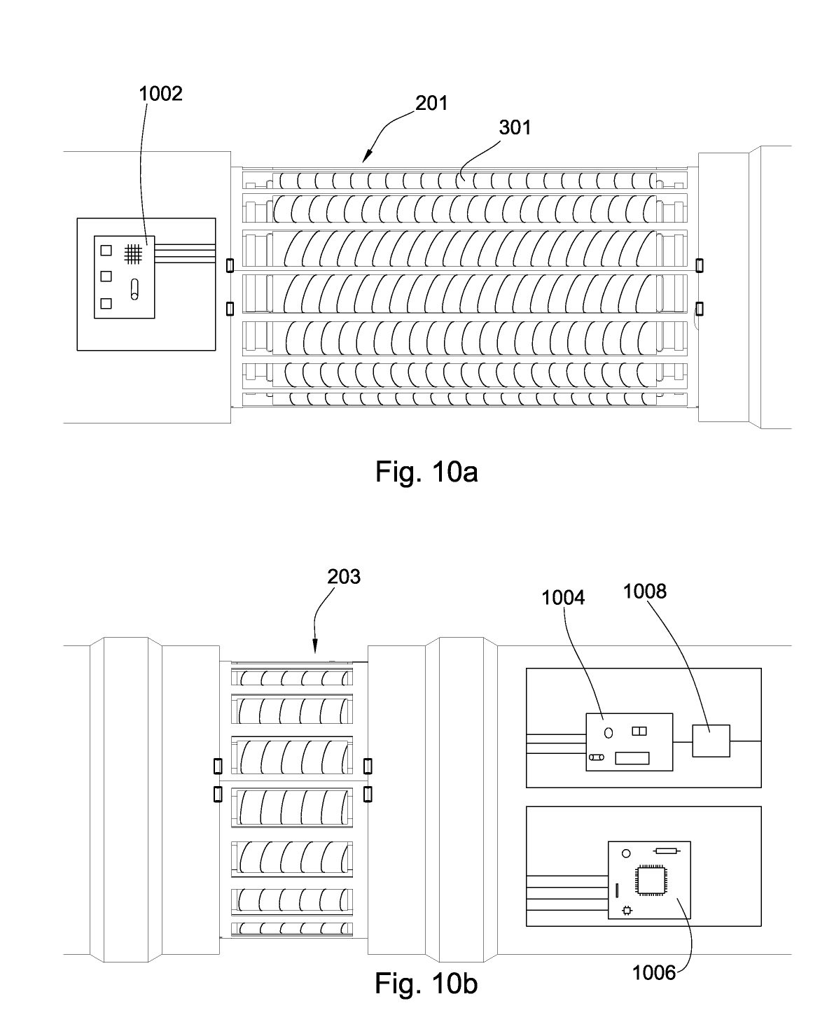

FIG. 3a is a side view of an embodiment of a transmitter 201 disposed within a tool string component 100 and FIG. 3b is a side view of an embodiment of receivers 203 disposed within a drill string component. The transmitter 201 may comprise an array of transmitter units 301 spaced circumferentially around the tool string component 100. The transmitter units 301 may comprise a ferrite core 308 wrapped in a transmitter wire 309. The transmitter 201 may be attached to a primary signal generator 1002 (See FIG. 10a). The primary signal generator 1002 sends an electrical signal into the transmitter wire 309 and this transmits an electromagnetic field into the surrounding formation.

The transmitter units 301 may lie substantially parallel to the body of the drill string. The transmitter units 301 may be independently excitable. Independently excitable units may focus the induction field in only a portion of the formation adjacent to the excitable units while the remaining portion of the formation is minimally affected or not affected at all. Furthermore it is believed that the ability to concentrate the field in portions of the formation adjacent the well bore will lead to directional measurements of the formation. Data received through directional measurement may verify a current drilling trajectory or it may reveal needed adjustments. Steering adjustments may be made by a steering system in communication with a downhole communication system, such as the system disclosed in U.S. Pat. No. 6,670,880, which is herein incorporated by reference for all that it discloses. An embodiment of a compatible steering system is disclosed in U.S. patent application Ser. No. 12/262,372 to Hall et al., which is herein incorporated by reference for all that it contains.

Each of receivers 203 may comprise an array of receiver units 303. The receiver units 303 may lie substantially parallel to a longitudinal axis of the body of the tool string component. Each of receivers 203 may also comprise a spool receiver unit 304 that may comprise a magnetically conductive core that is disposed perpendicular to the body of the drill string. Since the core of the spool receiver unit 304 and the receiver units 303 lie on different planes they may sense boundaries of the subterranean formation that the other cannot. In some embodiments, the receiver units 303 and the core of the spool receiver unit 304 are oriented such that they are not substantially perpendicular to each other, but are still adapted to sense boundary between subterranean strata at different angles.

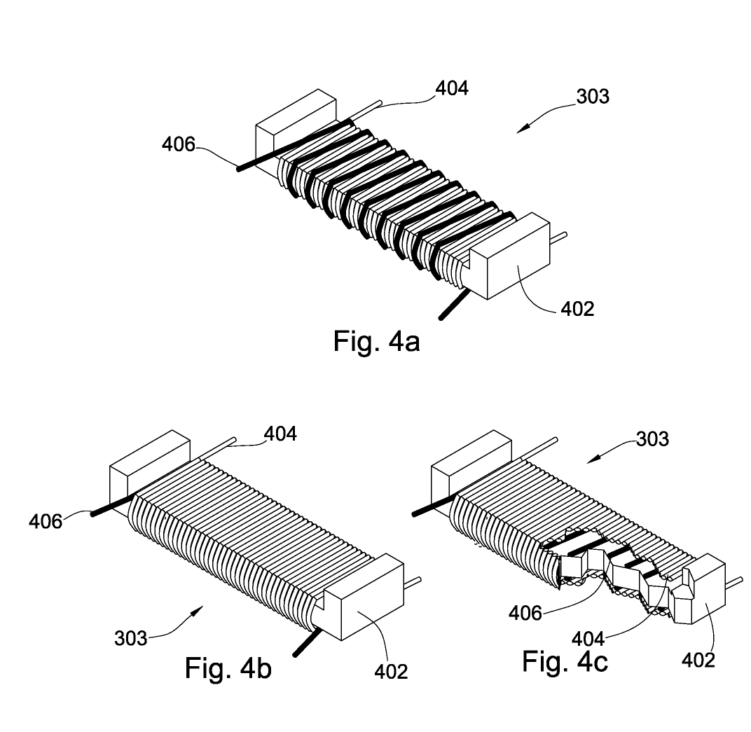

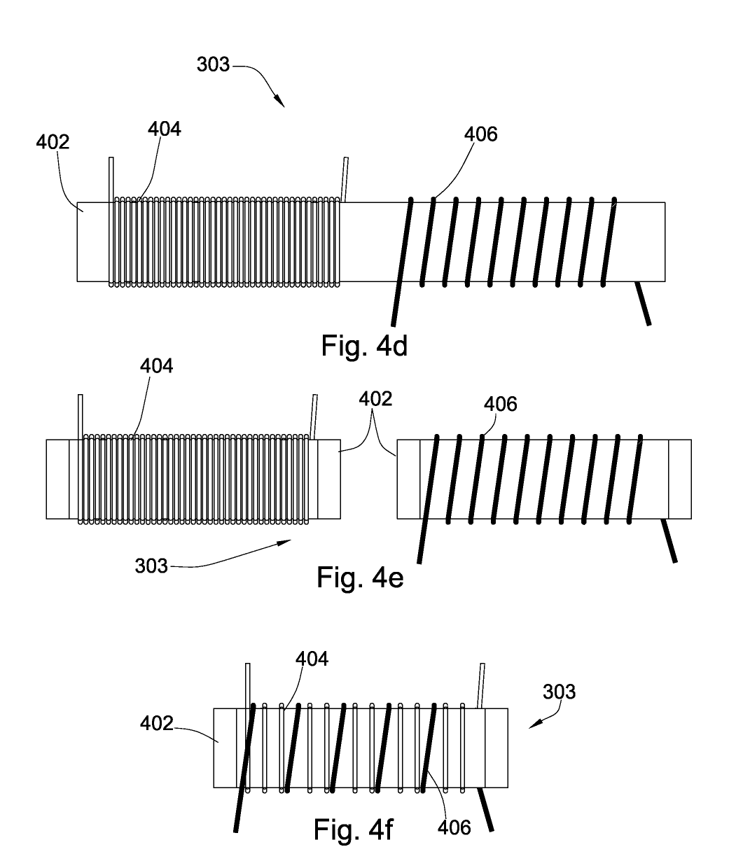

FIG. 4a discloses an embodiment of a receiver unit 303. The receiver unit 303 may comprise a ferrite core 402 wrapped in a first wire 404. The first wire 404 may be passive and attached to a measuring device 1006 (See FIG. 10b) capable of measuring the electromagnetic field induced into the receiver unit 303. The ferrite core 402 may also be wrapped in a second wire 406. The second wire 406 may be actively driven by a canceling signal generator 1004 (See FIG. 10b) to cancel the effects of the primary transmitted electromagnetic field on the receiver unit 303. The canceling signal generator 1004 may be attached to a comparator 1008 (See FIG. 10b) that is attached to the primary signal generator 1002. The comparator 1008 reads the signal generated by the primary signal generator 1002 and locks in to that signal as received by the receiver 203. The comparator 1008 then communicates to the canceling signal generator 1004 what signal needs to be transmitted through the second wire 406. When actively driven by a canceling signal generator the second wire 406 acts as a nulling coil.

The second wire 406 may be wrapped in the same direction as the first wire 404 or may be wrapped in an opposing direction of the first wire 404. The first wire 404 and the second wire 406 may have similar or different gauges. The number of coil turns of the first wire 404 may be the same or different to the number of coil turns of the second wire 406. In the preferred embodiment, the second wire 406 is wrapped in the opposite direction as the first wire 404, is the same gauge as the first wire 404, and is wound typically 10-30% of the windings of the first wire 404.

While a ferrite core has been described as the preferred embodiment, other materials may be used in place of ferrite to form the core. In various embodiments, the core may comprise iron, nickel, mu-metals, or other magnetically conducting materials.

In another embodiment there may not be a core at all with wire windings wrapped around an empty center.

The end of the cores may comprise a bend adapted to preferentially focus the magnetic field. The bend may be a substantially 90 degree as shown in FIGS. 4a-c. In other embodiments, the bend is more gradual, such as a curve. In other embodiments, the ends of the cores do not comprise a bend.

FIGS. 4b and 4c disclose another embodiment of a receiver unit 303. In this embodiment, a ferrite core 402 similar to that disclosed in FIG. 4a is first wrapped in the second wire 406 which may be actively driven by a current and then wrapped in the first wire 404 which is passive and may be attached to a measuring device 1006 (See FIG. 10b) capable of measuring the surrounding magnetic field.

FIG. 4d discloses another embodiment of a receiver unit 303 where a single ferrite core 402 is wrapped in a first wire 404 and a second wire 406. In this embodiment the first wire 404 is wrapped adjacent to the second wire 406.

FIG. 4e discloses another embodiment of a receiver unit 303 where multiple ferrite cores 402 are wrapped in a first wire 404 and a second wire 406. In this embodiment the first wire 404 is wrapped on a separate ferrite core 402 from the second wire 406.

FIG. 4f discloses another embodiment of a receiver unit 303 where a ferrite core 402 is wrapped in a first wire 404 and a second wire 406. In this embodiment the turns of the first wire 404 are interspersed with the turns of the second wire 406.

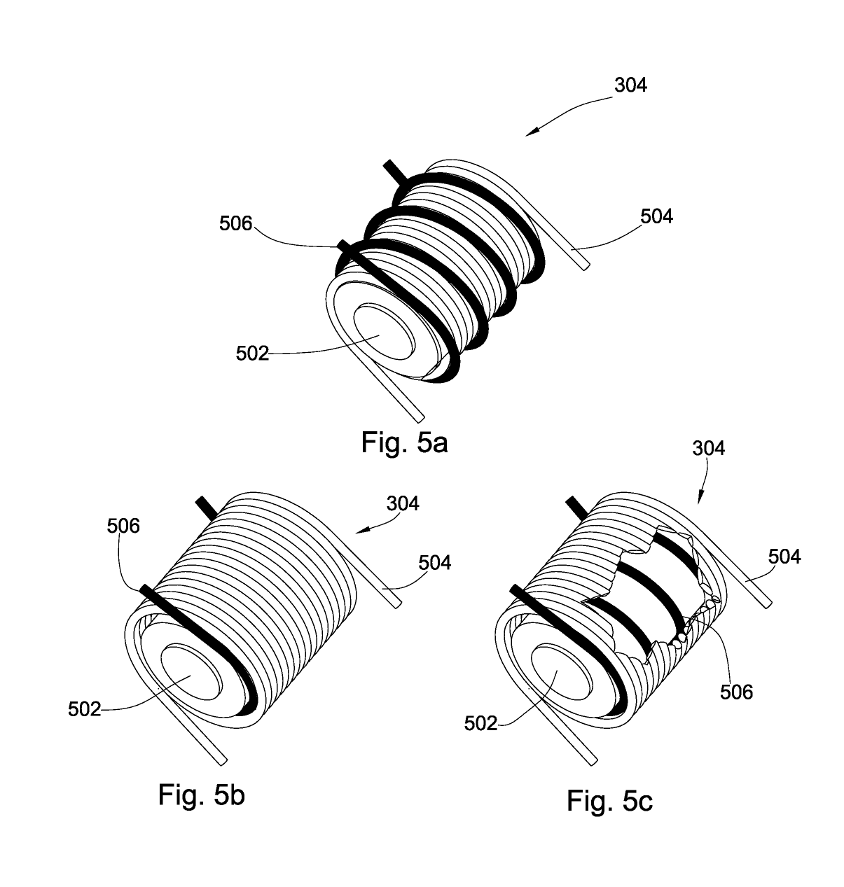

FIG. 5a discloses an embodiment of a spool receiver 304. The spool receiver may comprise a ferrite core 502 wrapped in a first wire 504. The first wire 504 may be passive and attached to a measuring device (not shown) capable of measuring the electromagnetic field induced into the receiver unit 304. The ferrite core 502 may also be wrapped in a second wire 506. The second wire 506 may be actively driven by a current set to cancel the effects of the primary transmitted electromagnetic field on the receiver unit 304. When actively driven by a canceling current the second wire 506 acts as a nulling coil. The second wire 506 may be wrapped in the same direction as the first wire 504 or may be wrapped in the opposite direction of the first wire 504. In the preferred embodiment, the second wire 506 is wrapped in the opposite direction as the first wire 504 and is wound typically 10-30% of the windings of the first wire 504.

FIGS. 5b and 5c disclose another embodiment of a spool receiver 304. In this embodiment, a ferrite core 502 similar to that disclosed in FIG. 5a is first wrapped in the second wire 506 which may be actively driven by a current and then wrapped in the first wire 504 which is passive and may be attached to a measuring device 1006 (See FIG. 10b) capable of measuring the induced magnetic field.

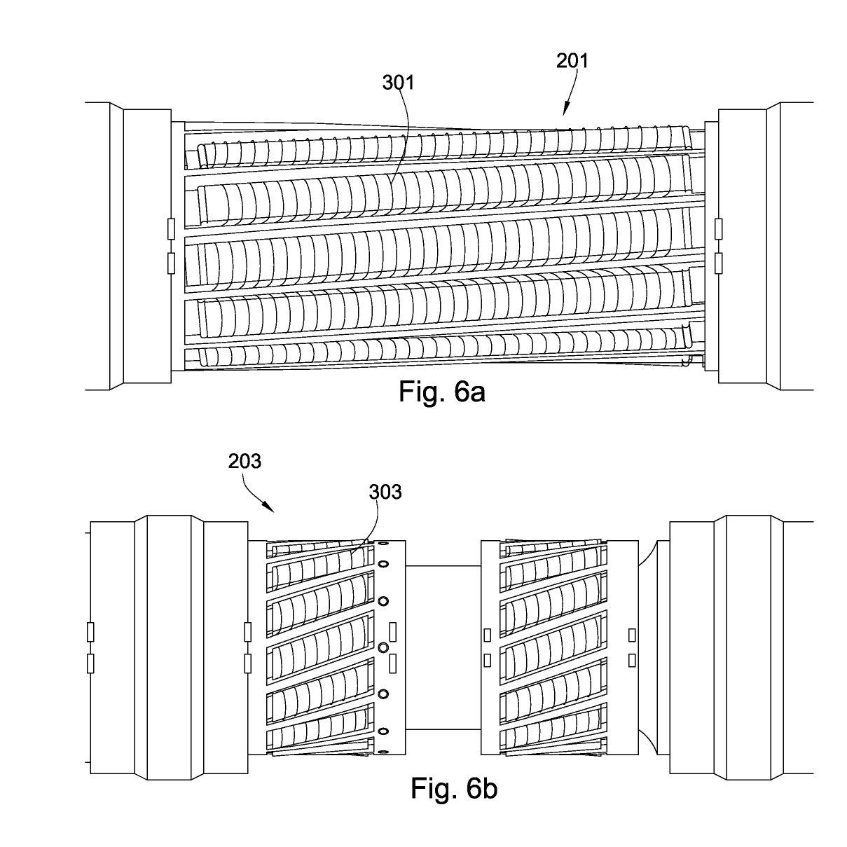

FIG. 6a is a side view of an embodiment of transmitter 201 disposed within a tool string component 100. In this embodiment the transmitter units 301 are tilted with respect to a central axis of the tool string component 100. FIG. 6b is a side view of an embodiment of receiver 203 where receiver units 303 are tilted with respect to a central axis of the tool string component 100. The tilt angle may be at any degree. In some embodiments, the tilt angle is between 10 and 50 degrees with respect to the central axis.

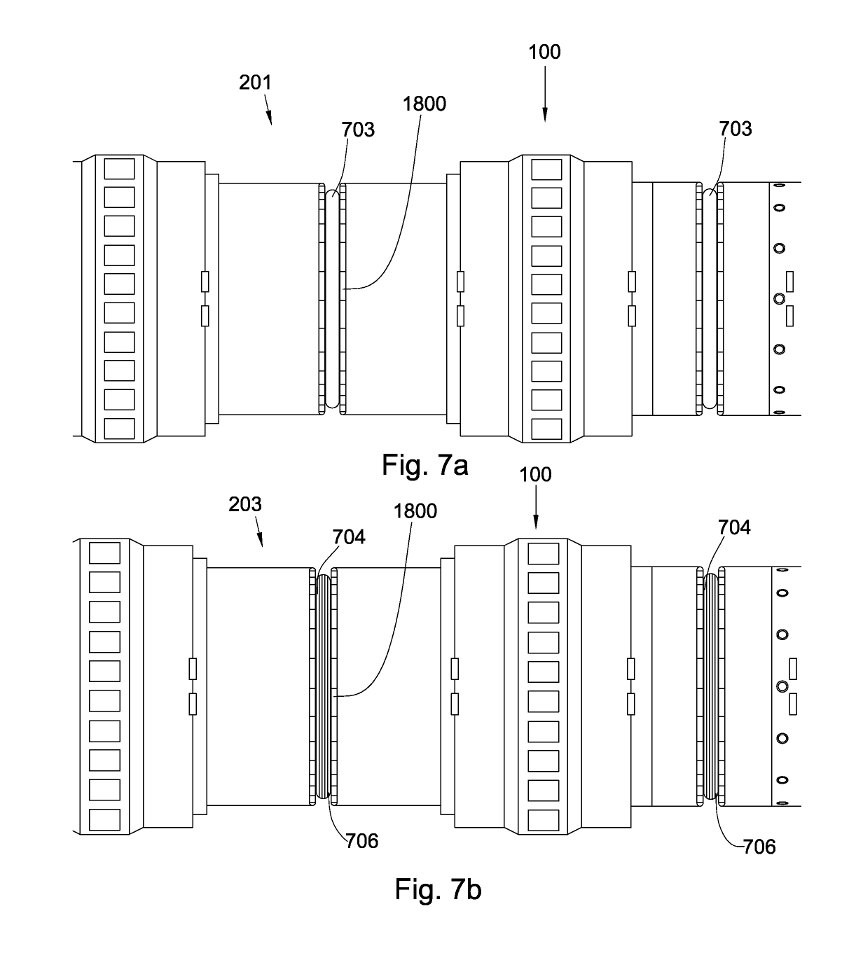

FIG. 7a depicts an embodiment of a transmitter 201 where the transmitter comprises wire windings 703 wound circumferentially around the tool string component 100. The wire windings 703 are disposed within a trough of magnetically conductive, electrically insulating (MCEI) material 1800 that is disposed adjacent a surface of the component and the coil. The MCEI material may comprise mu-metals, ferrite, and/or iron. An embodiment of a transmitter that may be compatible with the present invention is disclosed in U.S. patent application Ser. No. 11/676,494, which is herein incorporated by reference for all that it discloses.

FIG. 7b depicts an embodiment of receiver 203 where the receiver comprises first wire windings 704 wound circumferentially around the tool string component 100 and second wire windings 706 also wound circumferentially around the tool string component 100. The second wire windings 706 are actively driven by a current to cancel the effects of the primary transmitted electromagnetic field on the first wire windings 704. The wire windings 704 and 706 are disposed within a trough of magnetically conductive, electrically insulating (MCEI) material 1800 that is disposed adjacent a surface of the component and the coil. The MCEI material may comprise mu-metals, ferrite, and/or iron.

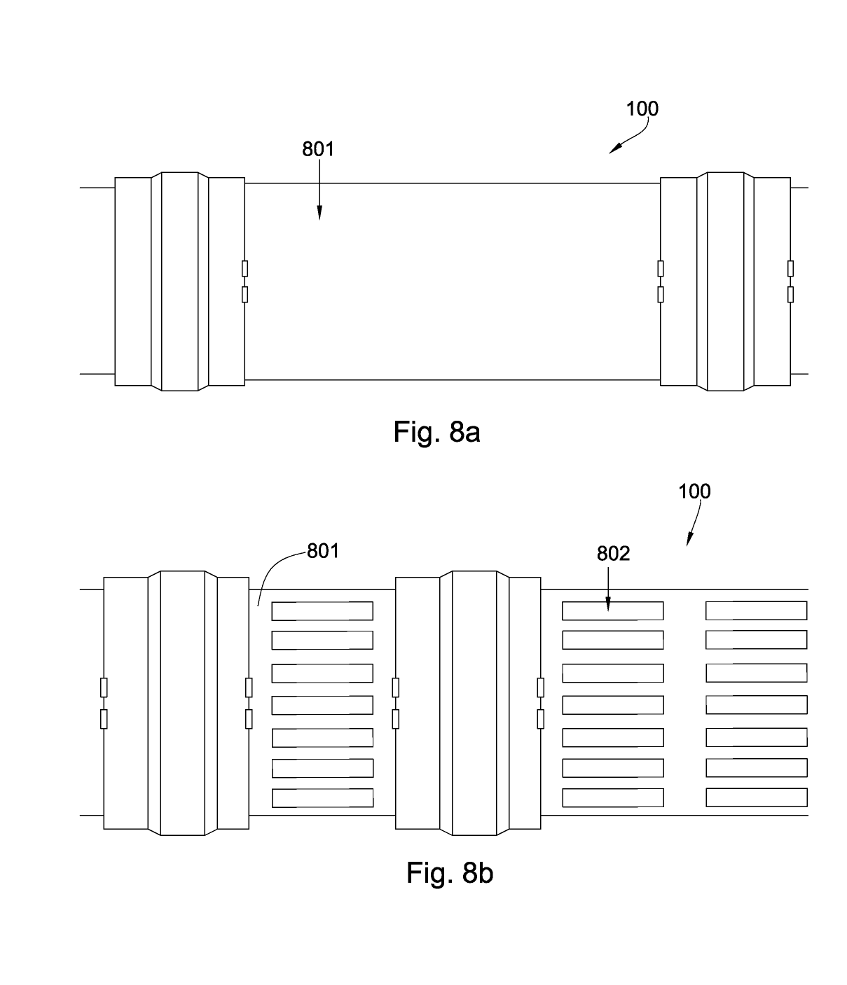

FIG. 8a depicts an embodiment of an irradiated plastic cover 801 disposed around a tool string component 100. It is believed that the irradiated plastic cover 801 may protect the transmitters 201 and receivers 203. It is also believed the irradiated plastic cover 801 will minimally interfere with the induction waves. The irradiated plastic cover 801 may comprise a material selected from a group of thermoplastic polymers. The cover may comprise a polytheretherkekytone (PEEK) material. In some embodiments, the plastic may comprise glass filled PEEK, glass filled Torlon®, Torlon®, polyamide-imide, glass filled polyamide-imide, thermoplastic, polyimides, polyamides or combinations thereof. The cover material may have a melting point between 333.9 degrees Celsius and 350 degrees Celsius. The cover material may have a tensile strength of between 70 megapascals and 100 megapascals. The cover may take the form of a sleeve disposed around the tool string component. FIG. 8b depicts an embodiment of an irradiated plastic cover 801 that comprises irradiated plastic windows 802.

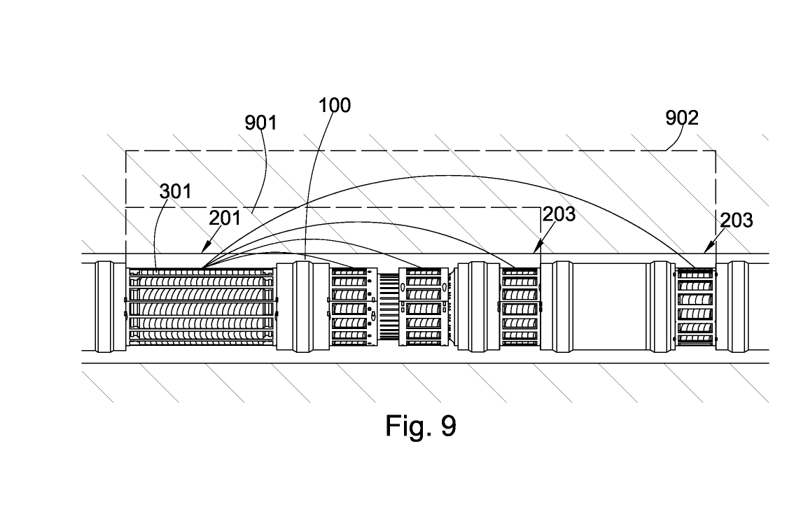

FIG. 9 depicts receivers 203 spaced at various distances from the transmitter 201. Transmitter unit 301 may be activated to generate an electromagnetic field that emanates into the surrounding formation and then later measured by receivers 203. The field measured by the receiver 203 closer to the transmitter 201 may reveal information regarding a section of the formation 901 that is close to the tool string component 100. While, the field measured by the receiver 203 farther from the transmitter 201 may reveal information regarding a section of the formation 902 that is farther from the tool string component 100. Multiple receivers 203 may be spaced at various distances from the transmitter 201 to gather information about sections of the surrounding formation at various depths. The electromagnetic field generated by the transmitter 201 may vary at different locations. Thus the canceling effect of the second wire 406 may vary depending on the location of the receiver 203.

FIG. 10a depicts an embodiment of a transmitter 201 with electronic assemblies exposed. Transmitter 201 is shown attached to a primary signal generator 1002.

FIG. 10b depicts an embodiment of a receiver 203 with electronic assemblies exposed. Receiver 203 is shown attached to a measuring devise 1006. Also shown is a canceling signal generator 1004 which may be attached to an active coil. The canceling signal generator 1004 may further be attached to a comparator 1008 that is attached to the primary signal generator 1002. As described previously, the comparator 1008 reads the signal generated by the primary signal generator 1002 and locks in to that signal as received by the receiver 203. The comparator 1008 then communicates to the canceling signal generator 1004 what signal needs to be transmitted.

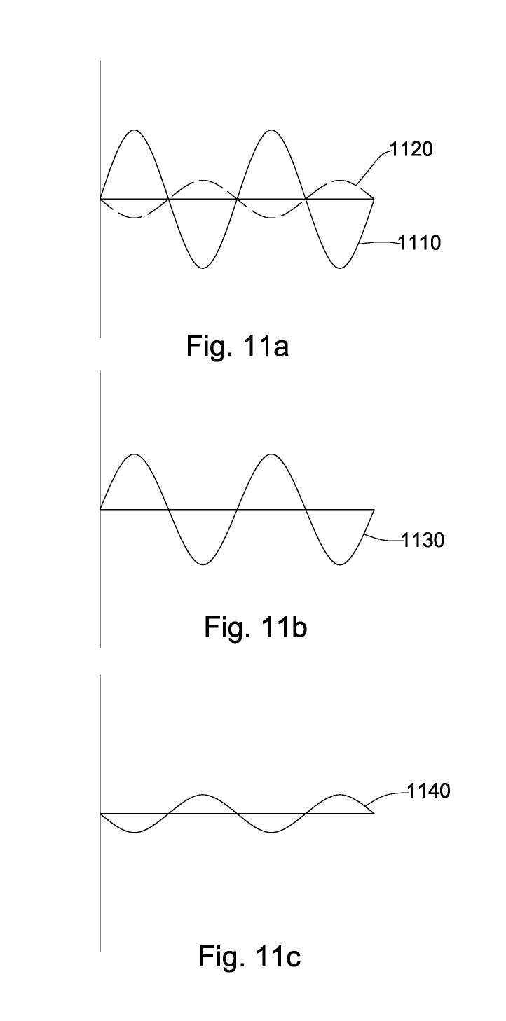

FIGS. 11a, 11b, and 11c are graphs of representative electromagnetic fields. FIG. 11a represents a primary electromagnetic field 1110 which may be transmitted into an earthen formation by a transmitter 201. The primary electromagnetic field 1110 generates an induced field 1120 within the formation. A receiver 203 may detect and measure a combination of the primary electromagnetic field 1110 and induced field 1120 as superimposed upon one another. FIG. 11b represents a combined field 1130 that may be formed by superimposing primary electromagnetic field 1110 on induced field 1120. A nulling coil may lock in to the primary electromagnetic field 1110 transmitted by the transmitter 201 and substantially cancel that field from the combined field 1130 so that the receiver 203 measures a resultant field 1140 as shown in FIG. 11c.

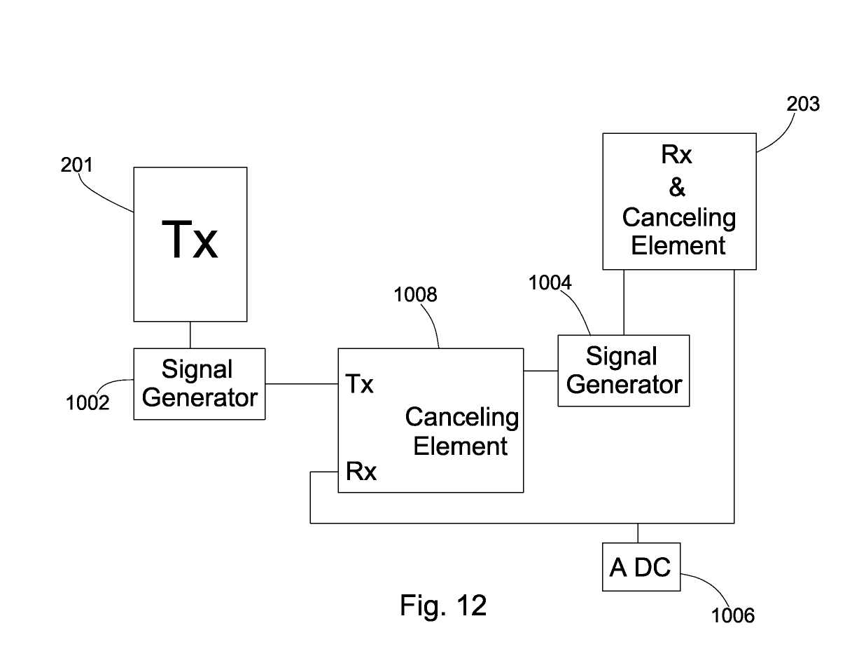

FIG. 12 is a block diagram of an embodiment of a resistivity receiver with cancelling element. In this embodiment, a transmitter 201 is attached to a primary signal generator 1002. The primary signal generator 1002 is also attached to a comparator 1008. A receiver 203 is attached to measuring device 1006. In some embodiments the measuring device 1006 may comprise an analog to digital converter. The measuring device may also be attached to the comparator 1008. The comparator 1008 may take the signal from the primary signal generator 1002 and lock into that signal as received by the receiver 203. Based on that signal, the comparator 1008 may send a canceling signal by way of a canceling signal generator 1004 to a canceling element at the receiver 203. This process may continue until the receiver 203 is substantially only measuring the induced signal 1120.

While the foregoing discussion has focused primarily on a resistivity system utilizing a resistivity transmitter, resistivity receiver and active coil, it should be understood that a sonic system, an ultrasonic system, a seismic system, or any other downhole sensing system known in the art could be employed in place of or along with the resistivity system and still be within the scope of the invention so long as the downhole sensing system employed a transmitter, receiver, and canceling element.

Whereas the present invention has been described in particular relation to the drawings attached hereto, it should be understood that other and further modifications apart from those shown or suggested herein, may be made within the scope and spirit of the present invention.

What is claimed is:

1. A downhole tool assembly, comprising:
An induction transmitter attached to a primary signal generator, the transmitter creates a generated field;
an induction receiver attached to a measuring device that measures a secondary induced field created by the induction transmitter; and
an active coil attached to a canceling signal generator that cancels out the generated field.

2. The assembly of claim 1, wherein the active coil is located at some distance from the transmitter and proximate the receiver.

3. The assembly of claim 1, comprising a plurality of active coils located between the transmitter and the receiver.

4. The assembly of claim 1, wherein the transmitter comprises a magnetic core and at least one coil turn disposed circumferentially about the magnetic core.

5. The assembly of claim 1, wherein the active coil comprises a magnetic core and at least one coil turn disposed circumferentially about the magnetic core.

6. The assembly of claim 1, wherein the canceling signal generator is attached to a comparator which is attached to the primary signal generator.

7. The assembly of claim 1, wherein the receiver comprises a magnetic core and at least one coil turn disposed circumferentially about the magnetic core.

8. The assembly of claim 7, wherein the active coil comprises a magnetic core and at least one coil turn disposed circumferentially about the magnetic core, and the gauge of the at least one coil turn forming the receiver is the same as the gauge of the at least one coil turn forming the active coil.

9. The assembly of claim 7, wherein the active coil comprises a magnetic core and at least one coil turn disposed circumferentially about the magnetic core, and the magnetic core forming the active coil lies on substantially the same axis as the magnetic core forming the receiver.

10. The assembly of claim 7, wherein the active coil comprises at least one coil turn disposed circumferentially about the same magnetic core as the receiver.

11. The assembly of claim 10, wherein the number of coil turns forming the active coil is 10% to 30% of the number of coil turns forming the receiver.

12. The assembly of claim 10, wherein the at least one coil turn disposed circumferentially about the magnetic core of the active coil overlaps the at least one coil turn disposed circumferentially about the magnetic core of the receiver.

13. The assembly of claim 10, wherein the at least one coil turn disposed circumferentially about the magnetic core of the receiver overlaps the at least one coil turn disposed circumferentially about the magnetic core of the active coil.

14. The assembly of claim 10, wherein coil turns disposed circumferentially about the magnetic core forming the receiver are interspersed with coil turns disposed circumferentially about the magnetic core forming the active coil.

15. The assembly of claim 1, wherein coil turns disposed circumferentially about the magnetic core forming the receiver are adjacent to coil turns disposed circumferentially about the magnetic core forming the active coil.

16. The assembly of claim 10, wherein the canceling signal generator is attached to a comparator which is attached to a receiver adapted to read the earth's magnetic field.

17. The assembly of claim 16, wherein the receiver is adapted to measure the earth's magnetic field while the transmitter is not generating an electromagnetic field.

18. The assembly of claim 16, wherein the canceling signal generator is adapted to cancel both a field of the primary signal generator and/or the earth's magnetic field.

19. The assembly of claim 1, wherein the receiver comprises wire windings disposed circumferentially about a downhole tool and disposed within a trough of magnetically conductive, electrically insulating material.

20. The assembly of claim 1, wherein the active coil comprises wire windings disposed circumferentially about a downhole tool and disposed within a trough of magnetically conductive, electrically insulating material.
